(19) United States
(12) Patent Application Publication
(10) Pub. No.: US 2002/0096848 A1
(43) Pub. Date: Jul. 25, 2002

(54) Shock absorbing skateboard device

(76) Inventors: Hau-Chang Wei, Tainan (TW); Dong-Seng Tsai, Tainan (TW)

Correspondence Address: Alan D. Kamrath, Rider, bennett, Egan & Arundel, 333 South Seventh Street, Suite 2000, Minneapolis, MN, 55402, US

(21) Appl. No.: 09/769,505

(22) Filed: Jan. 25, 2001

(51) Int. Cl. B62M 1/00; A63C 17/00

(52) U.S. Cl. 280/87.041; 280/11.28

(57) ABSTRACT

A shock-absorbing skateboard device has a main board, a downtube connected to the main board, a head tube connected to the downtube, a handle disposed on the head tube, a shock-absorbing mechanism connected to the head tube, a front wheel support plate connected to the shock-absorbing mechanism, two front wheels connected to the front wheel support plate, a rear wheel support frame connected to the main board, and a rear wheel connected to the rear wheel support frame.

### BACKGROUND OF THE INVENTION

The present invention relates to a skateboard device. More particularly, the present invention relates to a shock-absorbing skateboard device.

A conventional skateboard does not have a handle to direct a direction of movement. The direction of movement is controlled by the feet of the user only. Furthermore, the conventional skateboard cannot absorb shock.

### SUMMARY OF THE INVENTION

An object of the present invention is to provide a skateboard device which can absorb shock efficiently.

Another object of the present invention is to provide a skateboard device which has a confining device to confine a steering of the skateboard device.

Accordingly, a shock-absorbing skateboard device comprises a main board, a downtube connected to the main board, a head tube connected to the downtube, a handle disposed on the head tube, a shock-absorbing mechanism connected to the head tube, a front wheel support plate connected to the shock-absorbing mechanism, two front wheels connected to the front wheel support plate, a rear wheel support frame connected to the main board, and a rear wheel connected to the rear wheel support frame.

### BRIEF DESCRIPTION OF THE DRAWINGS

FIG. 1 is a perspective assembly view of a shock-absorbing skateboard device of a preferred embodiment in accordance with the present invention;

FIG. 2 is a front elevational view of a shock-absorbing mechanism of a preferred embodiment in accordance with the present invention;

FIG. 3 is a sectional view of a shock-absorbing mechanism of a preferred embodiment in accordance with the present invention;

FIG. 4 is a partially front elevational view of a shock-absorbing skateboard device of a preferred embodiment in accordance with the present invention; and

FIG. 5 is a schematic view illustrating an operation of a shock-absorbing skateboard device of a preferred embodiment in accordance with the present invention.

### DETAILED DESCRIPTION OF THE INVENTION

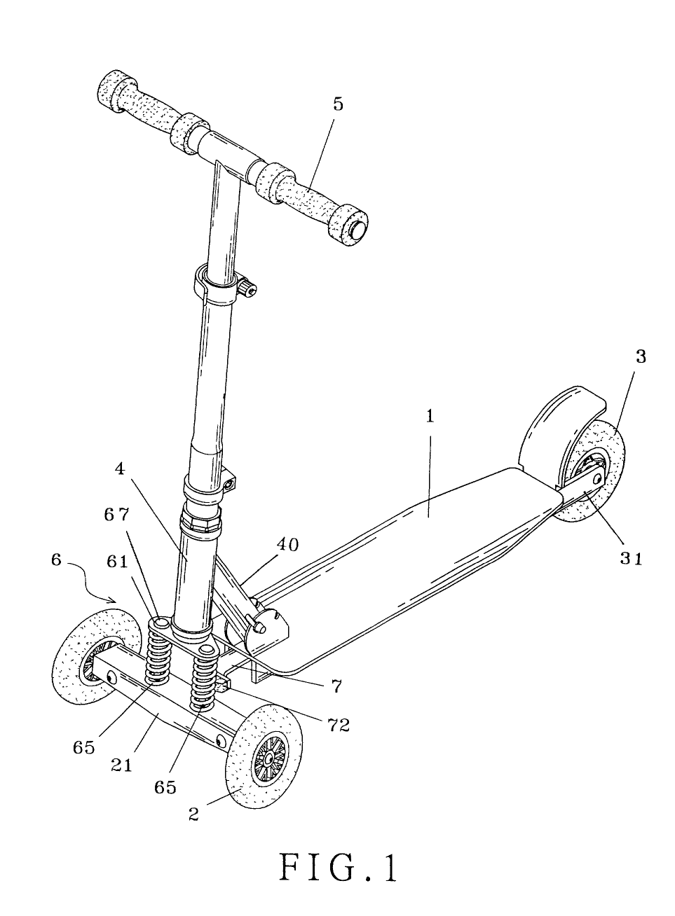

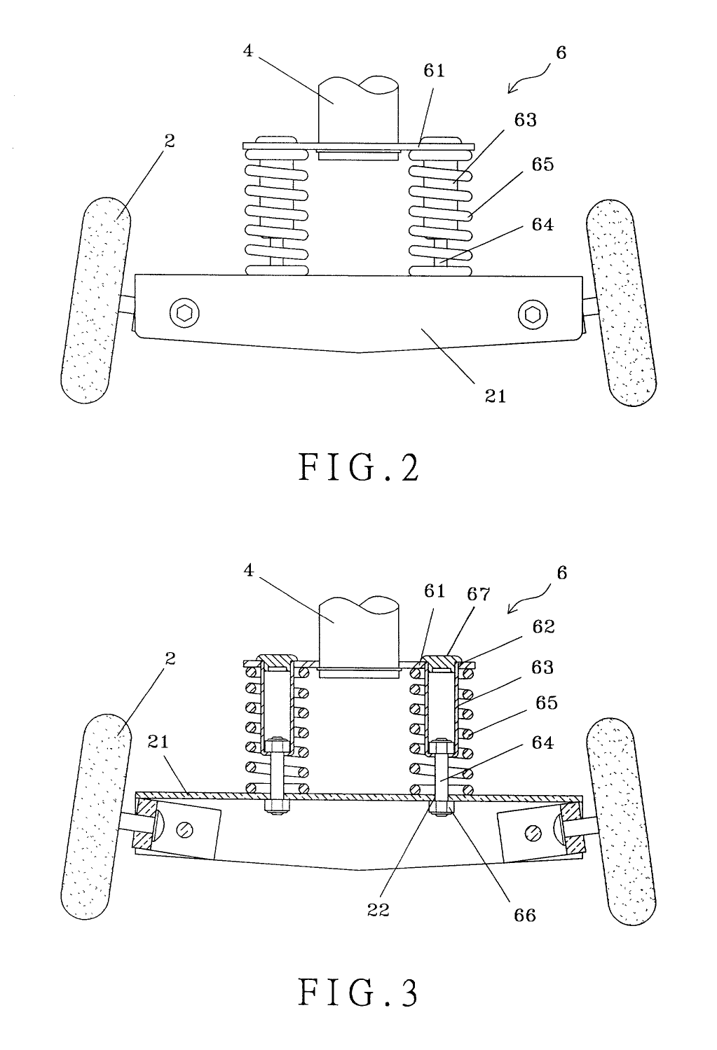

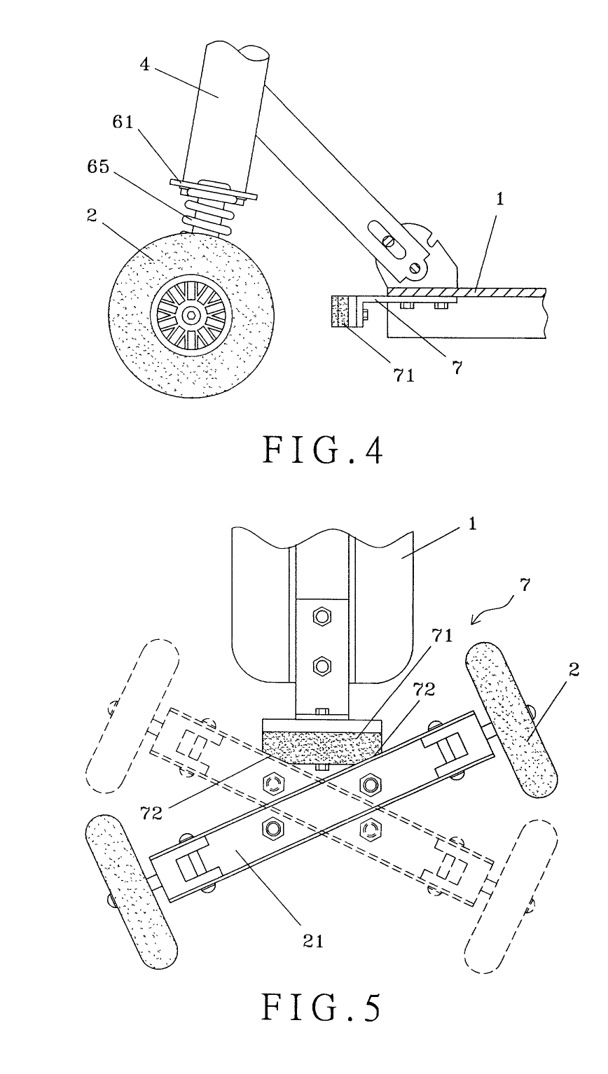

Referring to FIGS. 1 to 5, a shock-absorbing skateboard device comprises a main board 1, a downtube 40 connected to the main board 1, a head tube 4 connected to the downtube 40, a handle 5 disposed on the head tube 4, a shock-absorbing mechanism 6 connected to the head tube 4, a front wheel support plate 21 connected to the shock-absorbing mechanism 6, two front wheels 2 connected to the front wheel support plate 21, a rear wheel support frame 31 connected to the main board 1, and a rear wheel 3 connected to the rear wheel support frame 31.

The front wheel support plate 21 has two through apertures 22.

The shock-absorbing mechanism 6 has an upper seat 61 for receiving the head tube 4, two pipes 63 disposed on a bottom of the upper seat 61, two bolts 64 passing through the through apertures 22 of the front wheel support plate 21 for fastening the front wheel support plate 21 and the pipes 63 together, and two elastic elements 65 for enclosing the pipes 63. Two nuts 66 engage with the bolts 64.

The upper seat 61 has two through holes 62. Two fasteners 67 pass through the through holes 62 of the upper seat 61 for fastening the upper seat 61 and the pipes 63 together. A confining device 7 is disposed on a front portion of the main board 1. The confining device 7 has a front blocking bar 71 which has two bevel ends 72. The blocking bar 71 confines a rotation of the front wheel support plate 21.

The invention is not limited to the above embodiment but various modification thereof may be made. Further, various changes in form and detail may be made without departing from the scope of the invention.

I claim:

1. A shock-absorbing skateboard device comprises:
a main board,
a downtube connected to the main board,
a head tube connected to the downtube,
a handle disposed on the head tube,
a shock-absorbing mechanism connected to the head tube,
a front wheel support plate connected to the shock-absorbing mechanism,
two front wheels connected to the front wheel support plate,
a rear wheel support frame connected to the main board, and
a rear wheel connected to the rear wheel support frame.

2. The shock-absorbing skateboard device as claimed in claim 1, wherein the front wheel support plate has two through apertures.

3. The shock-absorbing skateboard device as claimed in claim 2, wherein the shock-absorbing mechanism has an upper seat for receiving the head tube, two pipes disposed on a bottom of the upper seat, two bolts passing through the through apertures of the front wheel support plate for fastening the front wheel support plate and the pipes together, and two elastic elements for enclosing the pipes, the upper seat has two through holes, and two fasteners pass through the through holes of the upper seat for fastening the upper seat and the pipes together.

4., The shock-absorbing skateboard device as claimed in claim 3, wherein a confining device is disposed on a front portion of the main board, and the confining device has a front blocking bar having two bevel ends.
